(19) United States
(12) Patent Application Publication
(10) Pub. No.: US 2024/0180088 A1
(43) Pub. Date: Jun. 6, 2024

(54) ALGONQUIN SAP COLLECTOR

(71) Applicant: Reginald Osagie Akpata, Pleasant Valley, NY (US)

(72) Inventor: REGINALD OSAGIE AKPATA, PLEASANT VALLEY, NY (US)

(21) Appl. No.: 18/074,013

(22) Filed: Dec. 2, 2022

(51) Int. Cl. A01G 23/14

(52) U.S. Cl. CPC A01G 23/14

(57) ABSTRACT

The Algonquin Tree Sap Collector is a food grade vessel attached to a sap producing tree by a food grade tubing hose clamped at the vessel storage container and at the Spline inserted into the tree. The food grade tubing is also clamped with a zip tie at the point said tubing enters into the vessel, discharging Sap into the collection vessel.

The Algonquin Tree Sap Collector may also have a web based app activated to inform the Farmer when each individual vessel has reached its fill point by virtue of web based notification from a measuring device inserted into the vessel.

### BACKGROUND OF THE INVENTION

For thousands of years indigenous peoples of the Mohican-Algonquin-Mohawk peoples of the North East American continent have used sap from an indigenous tree Acer saccharum (The Maple Tree) for many remedies and foods up to and including deriving sugar (sucrose) from sap “tapped” from the tree during a few key months in the Winter.

Observing this, immigrants from the 1600's adapted the process to produce a “syrup” that was commonly used as a condiment associated with “pancakes”.

The first innovation introduced in Maple sap collection was the open bucket, then came the introduction of the Spile, then the partially closed bucket, then the Spile was joined by interlocking tubing systems that running through the forest to a collection tank increased efficacy in collection with a loss in enjoyable forest habitat.

On the African continent a vaguely similar process of extraction of sap is used to extract a “Wine” from the Palm Tree; this sap is called “Palm Wine”.

The process of extraction is vaguely similar though on a vastly different schedule, and the Palm tree is tapped at its crown as opposed to the lower trunk as is the case with the Sugar Maple tree.

Also while Maple syrup requires a boiling process, Palm wine requires only a brief fermentation—“resting”— for it to be fully ready for consumption.
Palm wine may also be further fermented then boiled to deliver a product closer to Gin.

The Tree Sap Collector becomes significant in both cases for a similar reason: In both cases it ensures a “clean” product free of debris, up to and including small flying insects.

In the case of the Palm Wine tree, the collection device attached to food grade clear tubing then a spile at the collection point, with collection in a vessel at ground level reduces the need for a person to climb the tree to collect the “sap/wine” as “collection occurs on the ground instead of from a gourd attached to the crown at 30 to 40 feet.

Also the Tree Sap Collector allows for the introduction of sap collection measuring devices so in a manual collection system, the collector is notified of which Tree Sap Collection vessels are full and need to be emptied.

With the Palm Tree application this could result in vast savings in spilled overflows at tree top, the physical risk associated with daily scaling of a tall thin tree, and in both a significant saving in time in a still manual collection process.

Both applications become significant in a world that has shifted from focusing on production—and overproduction—to one focused on small producers leveraging technologies like web based efficacious process systems to enable stable and sustainable micro-production, as opposed to massive mono-crop agricultural systems.

### REFERENCES

1. Native American EthnoBotany, Daniel E. Moerman
2. U.S. Pat. No. 3,204,370 Maple Sap Spile, Sep. 7, 1965 R. M. Lamb
3. US 2015/0040472 A1 Perkins et al.

### BRIEF SUMMARY OF THE INVENTION

The Tree Sap Collector enables tree farmers small and large to efficaciously collect clean tree sap on an individual tree basis.

For small sap collectors with non contiguous Acer saccharum or Palm Trees on their properties, they are able to replicate the same efficacy in cleanliness as vast interlocking tube collection efforts native to larger efforts.

Where most innovations enhance large mono crop applications, the Tree Sap Collector is the small efficacious farmer's/tapper's dream.

The Tree Sap Collector consists of a food grade collection bucket with a sealed tube portal.

Clear food grade plastic tubing is inserted into the exact size portal in the lidded food grade collection bucket.

The other end is a closed loop attached by zip-tie to the Spile and the Spile to the drilled hole in the tree trunk forming a tight collection system that cannot be invaded by debris or insects.

A measuring device in the collection drum will identify the level for emptying, obliviating the labor intensive need for constant opening of each collection vessel to check for readiness to empty the vessel of collected Sap.

### Claims

The Algonquin Sap Collector will enable efficacious farming on an individual tree basis.

The Algonquin Tree Sap Collection device takes into consideration several factors in its efficacy.

### Claim

The collection of sap efficaciously and health safe, means that the same—or similar—levels of efficacy in contiguous tubing can be reached with an individual collection device without the restricting nature of threading tubes through a nature forest

It will encourage small producers to produce as the efficacy levels in terms of clean Sugar (sucrose from Acer saccharum) or Clean safe “wine” from Palm trees can be reached with the Algonquin Tree Sap Collector

The Algonquin Tree Sap Collector enables dual use of the forest.

First as a sap collection device in the winter sap collection months and as a Nature Walk during those same months, and during all other months of the year.

The Algonquin Tree Sap Collector will have a great impact on the community of people whose task it is using rudimentary safety tools to scale a 30-40 foot Palm Tree daily to manually check if the tree has produced sufficient sap to collect, and replacing a full receptacle with a new empty one.

### DETAILED DESCRIPTION OF THE INVENTION

The invention known as the Algonquin Tree Sap Collector is an invention in the USPTO category:
Class 47, Plant Husbandry
   50 & 51 subclass 11

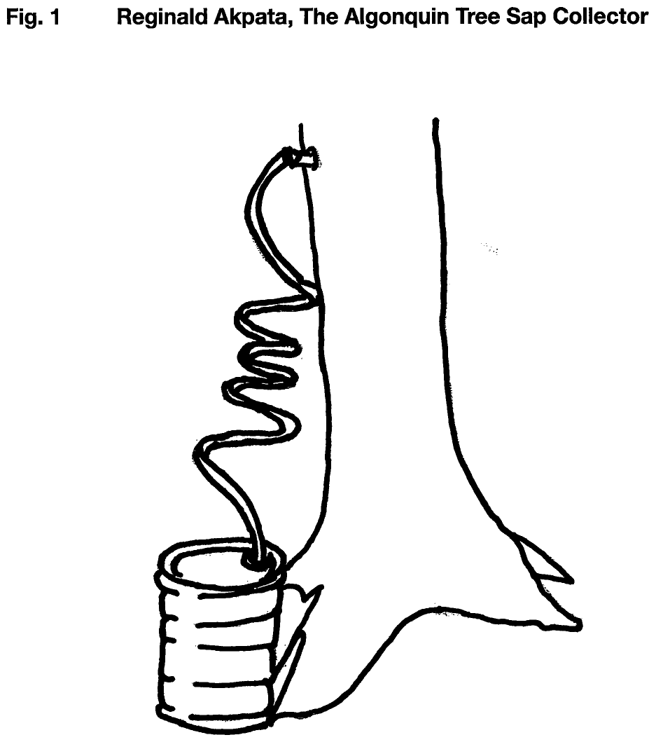

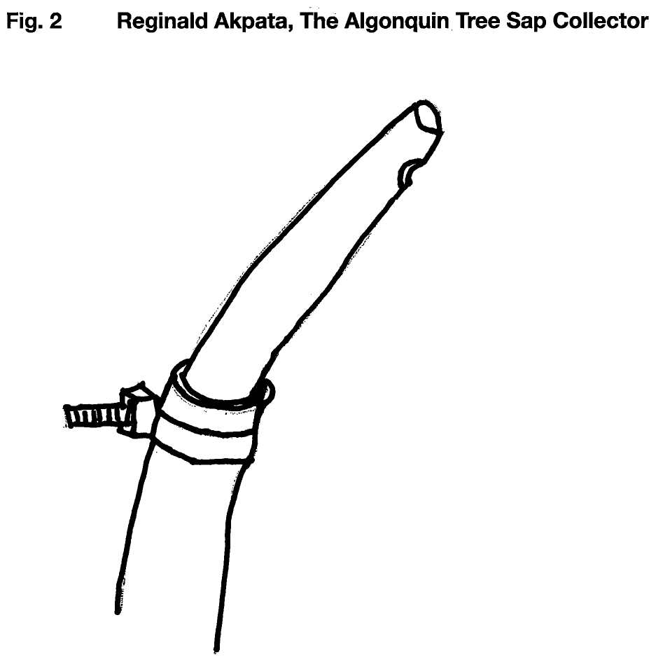

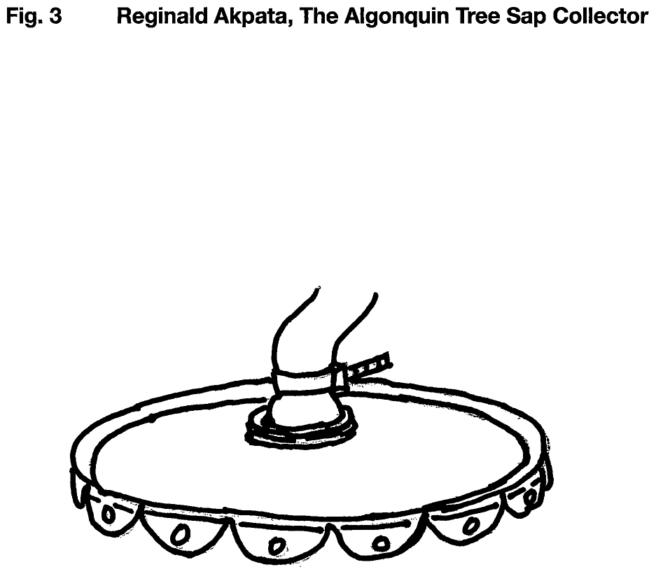

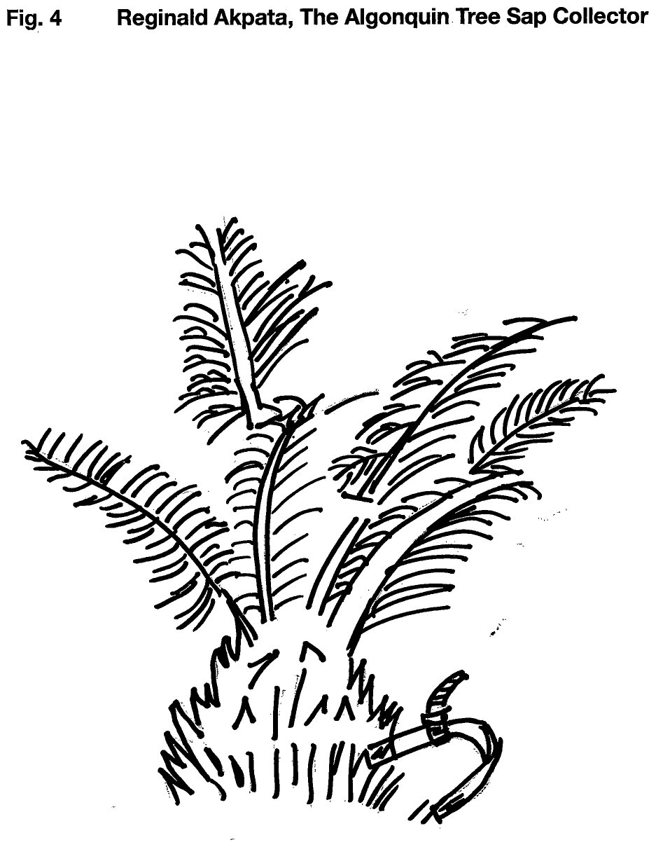

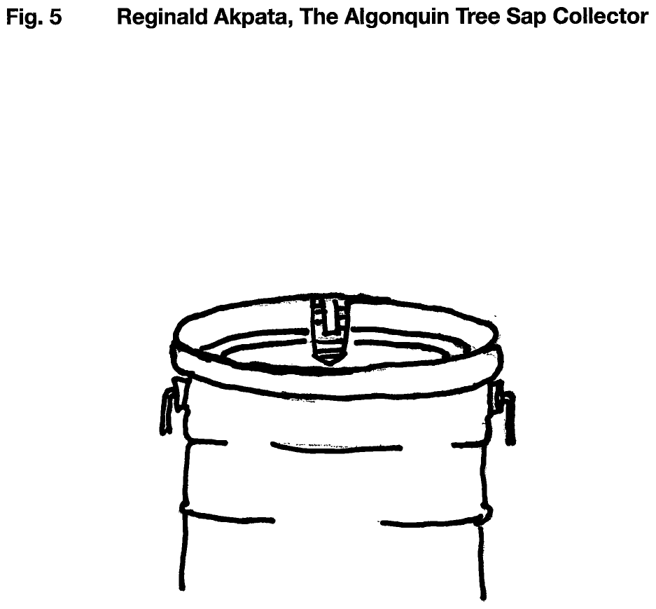

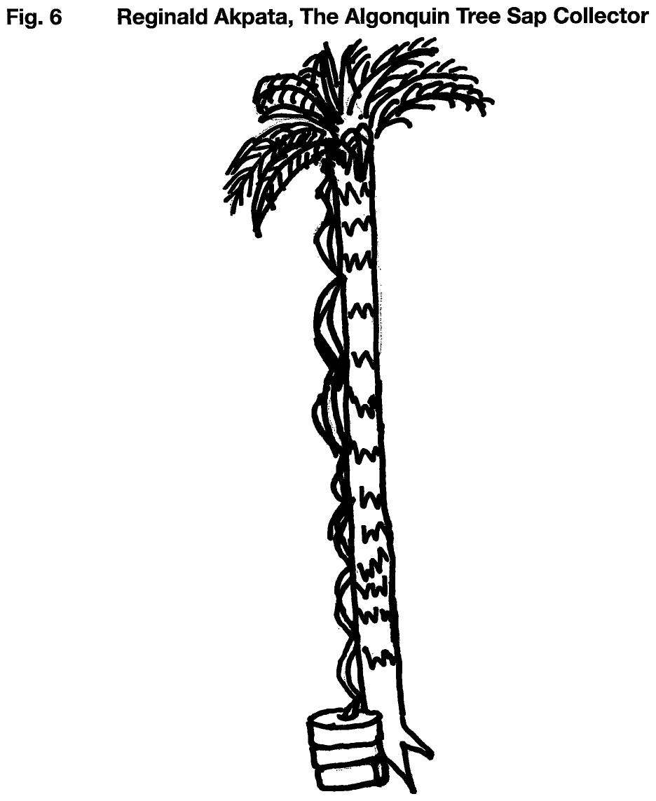

Specifically from FIG. 1 through FIG. 6 a vessel and system to convey sap from the trunk of a single tree to an individual receptor vessel.

Where on web application specification or by physical inspection, said sap is collected then before overflowing is identified for individual receptor vessel emptying.

The receptor vessel consists of a food grade bucket type vessel, with a sealing removable lid.

Within this removable lid, a hole is placed to receive the expectant receptor tubing while not allowing for debris or insects to inhabit said opening or collected sap when tube is placed and collection is imminent, has commenced, or has ended.

The food grade tubing is extended to appropriate height [3-4 feet for Acer saccharum, possibly 30-40 feet for Palm Tree sap tapping.

The receptor vessel is placed on the ground for stability, and is connected to the Spile receptacle point by food grade plastic tubing from 4 to 40 feet depending on application.

Either through a web based app with a sensor on the receptor vessel, or through physical inspection by collection personnel, an individual tree receptor collection schedule is enabled.

### DESCRIPTION

### Cross-Referenced to Related Applications

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-A REFERENCE OF MATERIAL SUBMITTED ON A OMPACT DISC OR AS A TEXTILE FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### SIMILAR DOCUMENTS

| Publication | Publication Date | Title |
|---|---|---|
| CA731871A | Apr. 12, 1966 | Flexible Maple Syrup Collecting |
| | | Tubing |
| CA724365A | Dec. 28, 1965 | Maple Sap Collecting System |
| CA718168A | Sep. 21, 1965 | Maple Sap Spile |
| CA735258A | May 31, 1966 | Tube Flexible |
| CA734793A | May 24, 1966 | Gathering Device |
| US3,204,370 | Sep. 7, 1965 | Maple Sap Spile |

### CLASSIFICATIONS

Classification 47, Plant Husbandry
50. Sap Buckets
51. (50.) Combined with cover and spout

### Non Patent Citations

| Name of | Publication | Date of Global | |
|---|---|---|---|
| Publication | Medium | Publication | Publication Search |
| Proof of | Instagram | Mar. 30, 2022 | #algonquinSugar and or |
| Publishing | | | @BarBeachBoy |
| Proof of | Facebook | Apr. 30, 2022 | @ReggieAkpata |
| Publishing | | | https:// |
| | | | m.facebook.com/ |
| | | | story.php? |
| | | | story_fbid=pfbid02H5G |
| | | | vsvXVKWPangDXMYFJ |
| | | | QCFFdN8hEzJhKLjdmB |
| | | | TWvqDqUzjVGzSfABYS |
| | | | S6E87RxGI&id=619274 |
| | | | 026&mibextid=TYB3uf |

1. The Algonquin Sap Collector will enable efficacious farming on an individual tree basis.
The Algonquin Tree Sap Collection device takes into consideration several factors in its efficacy.
1. The collection of sap efficaciously and health safe, means that the same—or similar—levels of efficacy in contiguous tubing can be reached with an individual collection device without the restricting nature of threading tubes through a nature forest
2. It will encourage small producers to produce as the efficacy levels in terms of clean Sugar (sucrose from Acer saccharum) or Clean safe “wine” from Palm trees can be reached with the Algonquin Tree Sap Collector
3. The Algonquin Tree Sap Collector enables dual use of the forest.
First as a sap collection device in the winter sap collection months and as a Nature Walk during those same months, and during all other months of the year.
4. The Algonquin Tree Sap Collector will have a great impact on the community of people whose task it is using rudimentary safety tools to scale a 30-40 foot Palm Tree daily to manually check if the tree has produced sufficient sap to collect, and replacing a full receptacle with a new empty one.
